(19) United States
(12) Patent Application Publication
(10) Pub. No.: US 2011/0066508 A1
(43) Pub. Date: Mar. 17, 2011

(54) Method for advertising in distributed media

(76) Inventor: Marilyn Louise Kern-Foxworth, Houston, TX (US)

(21) Appl. No.: 12/584,786

(22) Filed: Sep. 11, 2009

(51) Int. Cl. G06Q 30/00

(52) U.S. Cl. 705/14.69

(57) ABSTRACT

A method for advertising in media, comprising receiving an ad/catalog, determining the properties of the ad, generating a placement cost of ad containing said properties, receiving payment, recording payment for the properties of the ad and placing the ad. In one embodiment, the method comprises an advertiser submitting an ad/catalog for placement in a medium.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field of the Invention

This invention relates generally to the field of advertising. More specifically, the invention relates to a method of placing advertising space in distributed electronic and hardcopy media.

2. Background of the Invention

The association of a product with a particular experience, event or location can be a key ingredient to effective advertising. Advertisers regularly seek associations with quality experiences or locations. Additionally, a captive audience or the number of views may dictate the success of a particular ad campaign. As a result, ads can be found almost anywhere.

While magazines and periodicals routinely print ads, and in fact primarily exist on the ad dollars targeted to their readership; marketing and advertising in books has been relatively untapped as an advertising market. In part, this is due to the relatively low rate of turn over of a book once purchased. Additionally, the lifetime of a book may exceed the intended ad or product lifetimes.

Certain television, film, radio, and computer advertisements largely support the media in which they are distributed. Publisher or distributor assistance in targeting advertising to subscribers, readers, or viewers is limited to placing certain ads in conjunction with certain media contents. Furthermore, the distributed copies of certain electronic media, including compact disc (CDs), digital video discs (DVDs) and MP3s are relatively free from advertisements. Increasing popularity of mobile or cellphones have also created potential opportunities for advertisers. These recent developments in publishing music, video, books for distribution, both on paper and in electronic media, have established a new niche to expand marketing techniques as a means of reaching potential customers. Consequently, there is a need for a business method for advertising in published and distributed media.

### BRIEF SUMMARY

These and other needs in the art are addressed in one embodiment by a method for advertising in multiple classes of published or distributed media, comprising receiving an ad, determining the properties of the ad, generating a placement cost of ad containing said properties, receiving payment, recording payment for the properties of the ad and placing the ad.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of a business method for advertising in published media.

FIG. 2 illustrates another embodiment of a business method for advertising in published media.

### DETAILED DESCRIPTION OF THE PREFERRED EMBODIMENTS

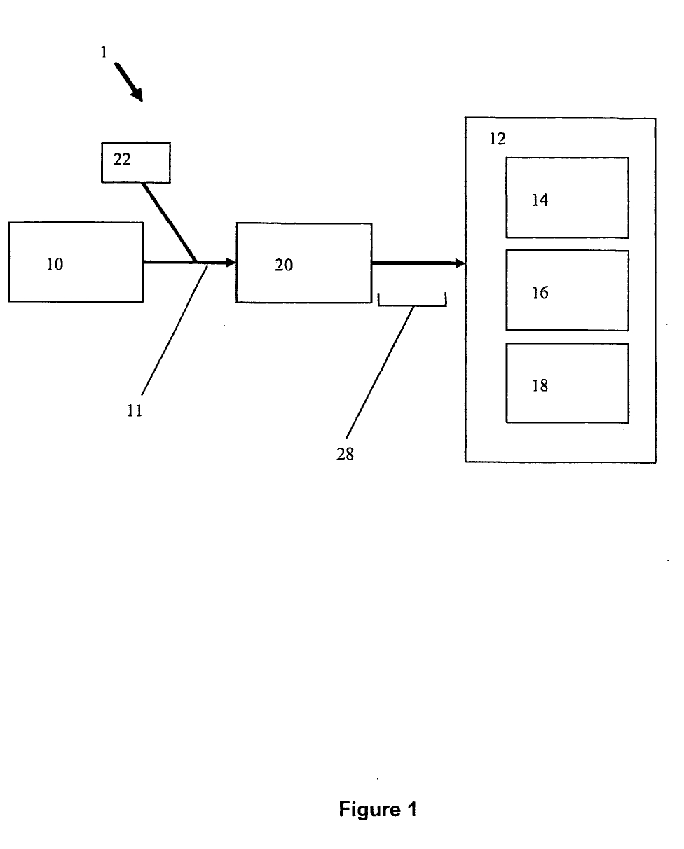

The business method 1 for advertising in published media is generally illustrated in FIG. 1. A publisher 10 receives advertiser 20 product graphics, or ads 22 from an electronic process 11. After submission the ads 22 are placed in published media, or content 12 such as books 14, e-books 16 and other content 18. Other content 18 comprises any copyright protected material for production, publishing, and/or distribution. Other content 18 may comprise, without limitation compact discs (CD), digital video discs (DVD), MP3s, and POD-casts. The placement of the ad 22 is dependent on a number of factors calculated in transaction steps 28.

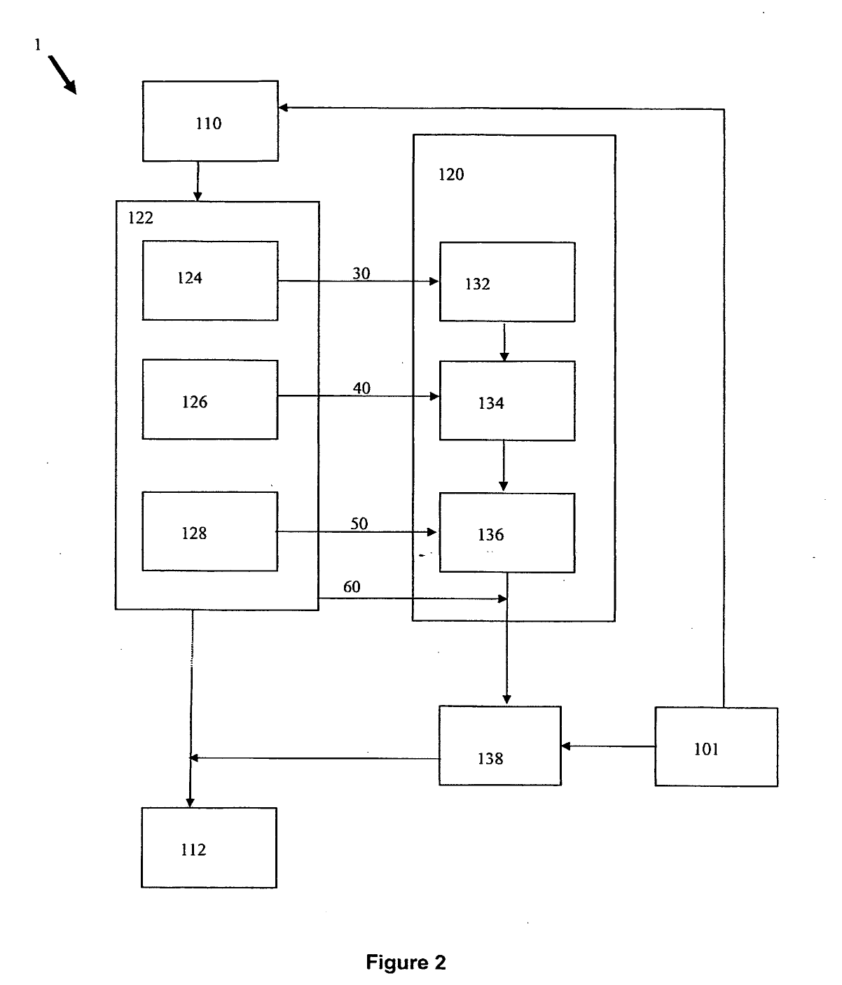

FIG. 2 is a second diagram of business method 1 for advertising in published media. The ad 122 is advertiser 120 generated content submitted to the publisher 110. The ad 122 is comprised of discrete properties 124 such as but not limited to dimensions, colors, verbiage, images, and film of product being sold. Discrete properties 124 may be related to content 112 ad 122 is to be placed within. In certain instances the ad 122 comprises camera ready or publishing ready copy. The properties 124 of the ad 122 are used to generate an ad cost 132 that define transaction step 30. Further transaction step 30 provides publisher 110 the rights to place the ad 122 in any content 112 that meets the discrete properties 124 of the ad 122. The ad cost 132 is calculated for all ads 122 containing similar properties. In certain instances ad cost 132 may be considered an “a la carte” option for advertisers. As publisher determines location and content 112 for placing ad 122, ad cost 132 may be a discounted cost. Discounts to ad cost 132 may comprise quantity of ads, multiple ads across multiple medium, location, and other considerations. Further, publisher may alter ad cost 132 to make provisions for pro-rating, in-kind, or other negotiated contracts.

Additional transactions 40 require further calculations in addition to ad cost 132. Additional transactions 40 include supplemental properties 126 of the ad 122 such as location in medium, relationship to medium, and product placement without limitation. The supplemental properties 126 are used to generate the supplemental cost 134 of the ad 122. Alternate transaction step 40 is calculated as a supplemental cost 134.

The supplemental properties 126 can be considered rights, shares, stakes, contracts, commodities or other contracts as known to one skilled in the art for controlling the location wherein the publisher 120 places the ad 122 in content 112. For example, certain advertisers 110 may prefer to have their ad 122 placed early in the content 112. Early placement may comprise, without limitation, in the front of a book, at the top of a webpage, or during the introduction of an audio-visual media. It can be envisioned that placement preference decreases as the ad is placed later in the content 112. In these instances, later in the content may comprise, without limitation, the back of the cover of a book, the bottom of a webpage, or during the conclusion and credits of an audio-visual media. The supplemental cost 134 may be higher for an advertiser 110 that chooses to place the ad 122 elsewhere in the content 112.

In certain instances it may be advantageous for a publisher 120 to further conduct premium transactions 50 with an advertiser 110. Premium transactions 50 are rights, shares, stakes, contracts, commodities or other contracts as known to one skilled in the art, that the advertiser 110 purchases from publisher 120. Premium transactions 50 control premium properties 128. A premium transaction 50 may further include the advertiser 120 selecting to place ad 122 in the works of a particular author, artist, group, company, or other content producer, without limitation. Further, a premium transaction may comprise an exclusivity clause, such that one advertiser's products are to be limited to association with a particular content producer.

Without limitation, premium properties 128 may include without limitation aroma ads, subliminal ads, auditory ads, scrolling ads, and/or foldout or pop-up ads. Placement of the ad 122 in relation to the story, plot, score, or other component of the media, for example a product placement within the topic or subject of the content 112 represents an envisioned premium transaction 50. In certain industries product placement is a coveted form of subliminal advertising. In an instance of product placement in text, the ad 122 may be placed on the opposing page from a direct reference in the content 112. Alternatively, the ad 122 may scroll across a perimeter portion of a screen in conjunction with the product placement within an audio-visual media. Without being limited by theory, in these instances the consumer perceives the ad 122 in the media, also notes the add 122, and associates the ad 122 with the surrounding media, and content reference. The perception may comprise at least in a subconscious or subliminal context. In further instances, the reference to a product or product placement may be differentiated from the surrounding media to draw attention to the product and the ad 122. Other product placement or visual cues in content 112 may comprise a premium property 128 without limitation.

The ad 122 can be produced for the advertiser 110 by the publisher 120. The production cost 60 of the ad 122 is factored into the algorithm for total ad cost 138 after to determining the properties 122, 124, 126. Alternatively, production cost 60 can be set up prior to determining properties 122, 124,126 so that the advertiser 110 grants publisher 120 some control over the content of the ad 122.

The calculation of the total ad cost 138 is the sum of ad costs 132, supplemental cost 134 and premium cost 136. Adjustments for client 101 or alternative distribution contracts are operated on the total ad cost 138. The total ad cost 138 is billed from the publisher 110 to the advertiser 120. Total ad cost 138 represents the final calculation of the formula and fixes the cost of placing the ad 122 in the content 112. Further the total ad cost 138 can be recorded, used, and referred to in future calculations of placing an ad 122 in a content 112.

Alternatively, a third party 101 acts as a distributor for the publisher 110. In premium transactions 50 of this sort the publisher 120 has the option to lower the total cost 138 associated with placing the ad 122. The total cost 138 is scaled in relation to the number, means, location and commitment of resources for distribution. Examples of distribution include promotional bundles, point of sale engagements, direct representative, associate sales or other means of distributing a book. The book can be distributed simultaneously with other media such as film, digital, audio, other recordings or other printed media. The third party 101 may comprise a client, a contractor, a sub-contractor or similar person or company that is recognized by the advertiser 110 and the publisher 120.

Without wishing to be limited by marketing or advertising theory, incorporating advertising into long duration media, such as books, including electronic books, and DVDs, CDs, or MP3s increases the overall value of the placing the ad to the advertiser. The typical time of possession of these media acts to impart a product association or long-term value to the product. An example of long-term value is customer association with a classic or defining work. Further association of a product with a particular genre of the media represents a form of branding. For instance, without limitation, association of a product with adventure lends the product the reputation of being for the adventurous. Additionally, associating the product with a book will target a particular subset of the population, using the example hereinabove: the product will be targeted to readers of adventure books. In an embodiment, the content 112 is books, wherein the publishing, copyrighting, or trade-marking of the material occurs less frequently than annually, and the content therein does not significantly and substantially change on a per edition, volume or printing basis. The book may be any as known to one in skilled in the art such as, without limitation, fiction, non-fiction, self-help, travel, cooking or other genre.

Alternatively, the ad 122 may comprise an entire catalog located within the media. Further, the ad 122 may comprise a catalog of products and services. In certain instances, alternating pages of the book may comprise the ad 122. Without being limited by marketing or advertising theory, merging advertising and entertainment, increases the value of the medium for both distributors of advertising, such as catalog distributors, and for publishers. For the advertisers, the cost of producing the catalog is offset by the capacity to sell the entertainment to prospective clients, customers or other purchasers of the product. In the case of publishers, the cost of publishing the text is offset by the advertisers paying for space. These benefits may be passed on to the customer in the form of lower prices for the entertainment of the text. In further instances, although the cost is lowered for the consumer it is not lowered as much as the cost offset to the publisher.

The execution of this method involves several distinct ways of advertising in books, e-books, CDs, DVDs, and cell phones. Ads will be placed in the referenced media for organizations, people, places, companies, products, services and any other entity that can be advertised. Another method involves the attachment of a product catalog that is fully integrated into the media that features products and services. With the described business method and commonplace use of the computer, advertising is now more practical and pragmatic in books, e-books, CDs, DVDs and cell phones. Consumers can easily be directed to corresponding websites or Internet resources that consistently update the information provided in the featured advertising. Similarly, websites and Internet resources can be used to update information when a consumer goods catalog is attached to a CD, DVD, e-book or cell phone. Updating information refers to the introduction, discontinuation, improvement, or modification of goods and services sold. An added benefit is the ability to drive traffic to websites and to instantly capture demographic information for further communication with customers, consumers, content providers, and publishers. Ultimately, this connection between this advertising method and the Internet can cultivate new customers.

Furthermore, regarding text mediums, new technological advances, such as print-on-demand (POD) which lets publishers print books as they are needed, have made it easier to offer advertising space and product catalogs in books. The use of paid advertising space and attached product catalogs in books are viable advertising options because these methods may be less expensive than advertising in other mediums. Due to printing cost differentials in printing volumes, printing large numbers of books can greatly improve the cost/benefit ratio and may prove to be extremely cost effective. In other words, depending on the number of books printed and the number of pages in the book, the advertising space cost to the publisher can be free or negligible. In certain applications, the cost/benefit factor may be negligible for adding advertising to CDs. DVDs, cell phones and e-books as well.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

We claim:

1. A method for advertising in media, comprising:
receiving an ad,
determining the properties of the ad;
generating a placement cost of ad containing said properties;
receiving payment;
recording payment for the properties of the ad; and
placing the ad.

2. The method of claim 1, wherein the ad is received by the publisher.

3. The method of claim 1, wherein the ad is submitted by the advertiser.

4. The method of claim 1, wherein ad is submitted by a third party.

5. The method of claim 1, wherein determining the properties of the ad comprise calculating the cost to reproduce the ad in the media.

6. The method of claim 1, wherein determining the properties of the ad comprise calculating the cost to distribute the media.

7. The method of claim 1, wherein the properties comprise at least one chosen from the group consisting of dimensions, color, appearance, images, wording, location, relationship to media, scent, sound, or combinations thereof.

8. The method of claim 1, wherein the ad is produced by the publisher.

9. The method of claim 1, wherein the placement cost is a sum of cost to reproduce and cost to distribute the ad in media.

10. The method of claim 1, wherein placing the ad comprises publisher control.

11. The method of claim 1, wherein placing the ad comprises advertiser control.

12. The method of claim 1, further comprising the media referencing the ad.

13. The method of claim 12, wherein media referencing the ad comprises a product placement

14. The method of claim 12, wherein media referencing the ad comprises a property of the ad.

15. The method of claim 1, wherein distribution comprises a property of the ad.

16. The method of claim 1, wherein the properties of the ad are divided.

17. The method of claim 16, wherein properties of the ad comprise at least two distinct levels.

18. The method of claim 17, wherein the cost of the levels generates at least two distinct cost ranges.

19. The method of claim 1, wherein the ad further comprises a catalog for at least one chosen from the group consisting of goods, services, and combinations thereof.
